(19) United States
(12) Patent Application Publication
(10) Pub. No.: US 2002/0089714 A1
(43) Pub. Date: Jul. 11, 2002

(54) LSI system and semiconductor device

(75) Inventor: Hiroyoshi Shimoyama, Tokyo (JP)

Correspondence Address: McDERMOTT, WILL & EMERY, 600 13th Street, N.W., Washington, DC, 20005-3096, US

(73) Assignee: MITSUBISHI DENKI KABUSHIKI KAISHA

(21) Appl. No.: 09/888,432

(22) Filed: Jun. 26, 2001

(30) Foreign Application Priority Data
Jan. 5, 2001 (JP) 2001-822

(51) Int. Cl. H04J 14/00; H04B 10/12

(52) U.S. Cl. 359/115; 359/173

(57) ABSTRACT

The LSI system is provided with a transmission-side LSI chip which outputs a plurality of data sequences as parallel data from a plurality of output terminals; a multiplexer which converts the parallel data output from the transmission-side LSI chip into serial data; a transmission module which converts the serial data into a light signal and transmits the light signal to an optical transmission line; a reception-side module which receives the light signal supplied via the optical fiber, converts the light signal into serial data, and outputs the serial data; a demultiplexer which converts the serial data output from the reception module to parallel data corresponding to a plurality of input terminals; and a reception-side LSI chip which receives the parallel data output from the demultiplexer via a plurality of input terminals.

### FIELD OF THE INVENTION

The present invention relates to an LSI system and a semiconductor device capable of transmitting large-capacity high-speed data input/output to/from a semiconductor chip such as an LSI chip by a simple device.

### BACKGROUND OF THE INVENTION

Conventionally, when receiving data by a light signal to a plurality of input terminals of a semiconductor chip, the received light signal is converted into electric signal by using a photoreceiving device array. Configuration of a conventional photoreceiving module is shown in FIG. 11. Light signal for each of input terminals of a semiconductor chip (IC) 105 is supplied via an optical fiber array 101. The optical fiber array 101 has a configuration in which optical fibers 101a are arranged in parallel. Each of the optical fibers 101a is optically coupled to each one of photoreceiving devices 102a of a photoreceiving device array 102. Each photoreceiving device is connected to each of the input terminals of the IC 105 via a wiring pattern 103 and a wire 104.

Since the photoreceiving module uses, however, the optical fiber array 101, a transmission medium becomes large and heavy. Since the physical size of the photoreceiving device array 102, that is, the number of arrays is limited, there is a problem that it is difficult to receive large-capacity high-speed data.

When light propagating through each of the optical fibers 101a in the optical fiber array 101 is a laser beam, sources for light generating, such as semiconductor lasers, of the number corresponding to the number of optical fibers 101a arranged in parallel are necessary. It causes a problem that the scale of the transmission-side device is accordingly large.

Furthermore, when performing large-capacity high-speed data communication by using a laser beam, it is difficult to realize high-speed response only by the photoreceiving devices 102a in the photoreceiving device array 102, and it disturbs large-capacity high-speed data communication.

On the other hand, in order to realize large-capacity high-speed data communication between semiconductor chips such as ICs, the device scale accordingly becomes large. There is a problem such that the advantage of the small size of a semiconductor chip cannot be sufficiently utilized.

### SUMMARY OF THE INVENTION

It is an object of this invention to provide an LSI system and a semiconductor device capable of realizing large-capacity high-speed data communication between semiconductor chips with a device scale as large as the semiconductor chips.

The LSI system according to one aspect of this invention comprises a transmission-side device and a reception-side device. The transmission-side device includes a transmission-side semiconductor chip which outputs a plurality of data sequences as parallel data from a plurality of output terminals; a multiplexer which converts the parallel data output from the transmission-side semiconductor chip into serial data; and an electro-optic converting module which converts the serial data into a light signal and transmits the light signal to an optical transmission line. On the other hand, the reception-side device includes a photoelectric converting module which receives the light signal supplied via the optical transmission line, converts the light signal into serial data, and outputs the serial data; a demultiplexer which converts the serial data output from the photoelectric converting module to parallel data corresponding to a plurality of input terminals; and a reception-side semiconductor chip which receives the parallel data output from the demultiplexer via the plurality of input terminals.

According to the above-mentioned aspect, on a transmission-side device, the transmission-side semiconductor chip outputs a plurality of data sequences as parallel data from a plurality of output terminals. The multiplexer converts the parallel data output from the transmission-side semiconductor chip into serial data. The electro-optic converting module converts the serial data into a light signal and transmits the light signal to an optical transmission line. On the other hand, on the reception-side device, the photoelectric converting module receives the light signal supplied via the optical transmission line, converts the light signal into serial data, and outputs the serial data. The demultiplexer converts the serial data output from the photoelectric converting module to parallel data corresponding to a plurality of input terminals. The reception-side semiconductor chip receives the parallel data output from the demultiplexer via the plurality of input terminals. Consequently, an effect such that the transmission-side device and the reception-side device can perform large-capacity high-speed data communication with the device scale almost equal to that of the transmission-side semiconductor chip and the reception-side semiconductor chip is produced.

The LSI system according to another aspect of this invention comprises a semiconductor chip which outputs a plurality of data sequences from a plurality of output terminals as parallel data and receiving parallel data from a plurality of input terminals; a multiplexer connected to the plurality of output terminals, which converts the parallel data output from the semiconductor chip to serial data; a demultiplexer connected to the plurality of input terminals, which converts the serial data supplied to the semiconductor chip to parallel data; an electro-optic converting module which converts the serial data output from the multiplexer into a light signal and transmits the light signal to an optical transmission line; and a photoelectric converting module which converts the light signal received via the optical transmission line into serial data and outputs the serial data to the demultiplexer.

According to the above-mentioned aspect, a semiconductor chip outputs a plurality of data sequences from a plurality of output terminals as parallel data. The multiplexer is connected to the plurality of output terminals and converts the parallel data output from the semiconductor chip to serial data. The electro-optic converting module converts the serial data output from the multiplexer into a light signal and transmits the light signal to an optical transmission line. On the other hand, the photoelectric converting module converts the light signal received via the optical transmission line into serial data and outputs the serial data to the demultiplexer. The demultiplexer is connected to the plurality of input terminals, and converts the serial data supplied to the semiconductor chip into parallel data. The semiconductor chip receives the parallel data by a plurality of input terminals. Consequently, an effect such that, with the device scale almost equal to that of the semiconductor chip, large-capacity, high-speed, bi-directional data communication can be performed is produced.

The semiconductor device according to still another aspect of this invention comprises a transmission-side semiconductor chip which outputs a plurality of data sequences as parallel data from a plurality of output terminals; a multiplexer which converts the parallel data output from the transmission-side semiconductor chip into serial data; and an electro-optic converting module which converts the serial data into a light signal and transmits the light signal to an optical transmission line.

According to the above-mentioned aspect, the transmission-side semiconductor chip outputs a plurality of data sequences as parallel data from a plurality of output terminals. The multiplexer converts the parallel data output from the transmission-side semiconductor chip into serial data. The electro-optic converting module converts the serial data into a light signal and transmits the light signal to an optical transmission line. Consequently, an effect such that large-capacity, high-speed broadcasting data communication can be performed with a device scale almost equal to that of the transmission-side semiconductor chip is produced.

The semiconductor device according to still another aspect of this invention comprises a photoelectric converting module which receives a light signal supplied via an optical transmission line, converts the light signal into serial data, and outputs the serial data; a demultiplexer which converts the serial data output from the photoelectric converting module to parallel data corresponding to a plurality of input terminals; and a reception-side semiconductor chip which receives the parallel data output from the demultiplexer via the plurality of input terminals.

According to the above-mentioned aspect, the photoelectric converting module receives a light signal supplied via an optical transmission line, converts the light signal into serial data, and outputs the serial data. The demultiplexer converts the serial data output from the photoelectric converting module to parallel data corresponding to a plurality of input terminals. The reception-side semiconductor chip receives the parallel data output from the demultiplexer via the plurality of input terminals. Consequently, an effect such that data of a large capacity can be received at high speed with a device scale almost equal to that of the reception-side semiconductor chip is produced.

The semiconductor device according to still another aspect of this invention comprises a semiconductor chip which outputs a plurality of data sequences from a plurality of output terminals as parallel data and receiving parallel data from a plurality of input terminals; a multiplexer connected to the plurality of output terminals, which converts the parallel data output from the semiconductor chip to serial data; a demultiplexer connected to the plurality of input terminals, which converts the serial data supplied to the semiconductor chip into parallel data; an electro-optic converting module which converts the serial data output from the multiplexer to a light signal and transmits the light signal to an optical transmission line; and a photoelectric converting module which converts the light signal received via the optical transmission line into serial data and outputs the serial data to the demultiplexer.

According to the above-mentioned aspect, the semiconductor chip outputs a plurality of data sequences from a plurality of output terminals as parallel data. The multiplexer is connected to the plurality of output terminals, and converts the parallel data output from the semiconductor chip to serial data. The electro-optic converting module converts the serial data output from the multiplexer to a light signal and transmits the light signal to an optical transmission line. On the other hand, the photoelectric converting module converts the light signal received via the optical transmission line into serial data and outputs the serial data to the demultiplexer. The demultiplexer is connected to the plurality of input terminals and converts the serial data supplied to the semiconductor chip into parallel data. The semiconductor chip receives the parallel data by a plurality of input terminals. Thus, an effect such that large-capacity, high-speed, bi-directional data communication can be performed with a device scale almost equal to that of the semiconductor chip is produced.

Other objects and features of this invention will become apparent from the following description with reference to the accompanying drawings.

### BRIEF DESCRIPTION OF THE DRAWINGS

FIG. 1 is a diagram showing a schematic configuration of an LSI system according to a first embodiment of the invention;

FIG. 2 is a diagram showing a detailed configuration of a transmission module illustrated in FIG. 1;

FIG. 3 is a diagram showing a detailed configuration of a reception module illustrated in FIG. 1;

FIG. 4 is a diagram showing the configuration of a transmission LSI chip in an LSI system according to a second embodiment of the invention;

FIG. 5 is a diagram showing the configuration of a transmission-side module in an LSI system according to a third embodiment of the invention;

FIG. 6 is a diagram showing a schematic configuration of an LSI system according to a fourth embodiment of the invention;

FIG. 7 is a diagram showing a schematic configuration of an LSI system according to a fifth embodiment of the invention;

FIG. 8 is a diagram showing the configuration of a frequency converter on the transmission-side illustrated in FIG. 7;

FIG. 9 is a diagram showing the configuration of a frequency converter on the reception-side illustrated in FIG. 7;

FIG. 10 is a diagram showing a schematic configuration of an LSI system according to a sixth embodiment of the invention; and

FIG. 11 is a diagram showing the configuration of a conventional photoreceiving module.

### DESCRIPTION OF THE PREFERRED EMBODIMENTS

Preferred embodiments of the LSI system and the semiconductor device according to the invention will be described in detail hereinbelow with reference to the accompanying drawings.

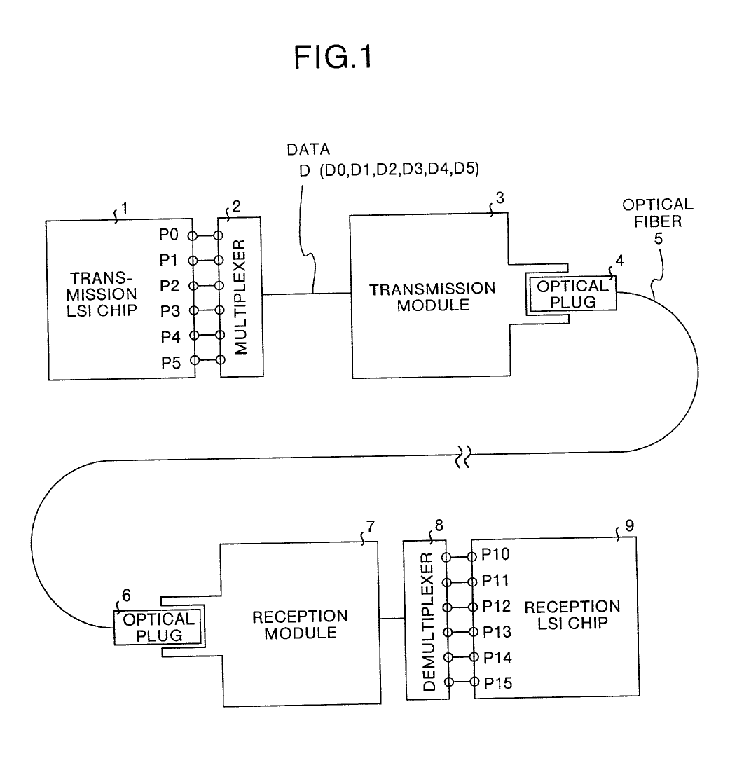

FIG. 1 is a diagram showing a general configuration of an LSI system as a first embodiment of the invention. In FIG. 1, the LSI system has a transmission LSI chip 1 for outputting a transmission data series from a plurality of output terminals P0 to P5, and a reception LSI chip 9 for receiving the data series via a plurality of input terminals P10 to P15.

The transmission LSI chip 1 is a semiconductor chip and is connected to a multiplexer 2 having a plurality of input terminals corresponding to the plurality of output terminals P0 to P5. The reception LSI chip 9 is a semiconductor chip and is connected to a demultiplexer 8 having a plurality of output terminals corresponding to the plurality of input terminals P10 to P15. The transmission LSI chip 1 and the multiplexer 2 are connected to each other and the reception LSI chip 9 and the demultiplexer 8 are connected to each other via wires, Al wires, Au wires, or Cu wires or a wiring pattern. In other words, the transmission LSI chip 1 and the multiplexer 2 are physically separated from each other, and the reception LSI chip 9 and the demultiplexer 8 are physically separated from each other.

The multiplexer 2 receives the data series output from the output terminals P0 to P5 of the transmission LSI chip 1 in a time division manner and converts and outputs the reception data to serial data. On the other hand, the demultiplexer 8 demultiplexes the serial data output from a reception module 7 and outputs resultant data to the input terminals P10 to P15 of the reception LSI chip 9.

A transmission module 3 is connected to the multiplexer 2, and converts the serial data output from the multiplexer 2 into a light signal, and outputs the light signal. The light signal output from the transmission module 3 is transmitted via an optical plug 4, an optical fiber 5, and an optical plug 6 to the reception module 7. The reception module 7 is connected to the demultiplexer 8, converts the light signal supplied from the optical plug 6 into an electric signal, and outputs it as serial data to the demultiplexer 8.

The optical fiber 5 takes the form of a plastic optical fiber. The plastic optical fiber is currently widely used as an optical transmitting medium of optical communication among cities. The plastic optical fiber has a core diameter which is about 20 to 100 times as large as that of a silica single-mode optical fiber having a core diameter of about 10 μm. Consequently, precise alignment with an optical device is not required, precision of parts and mounting precision can be largely loosened, and an optical link with a simple configuration can be realized. That is, the core is large and connection of optical fibers is easy, so that connection of a light signal is made possible without requiring a special technique and tools.

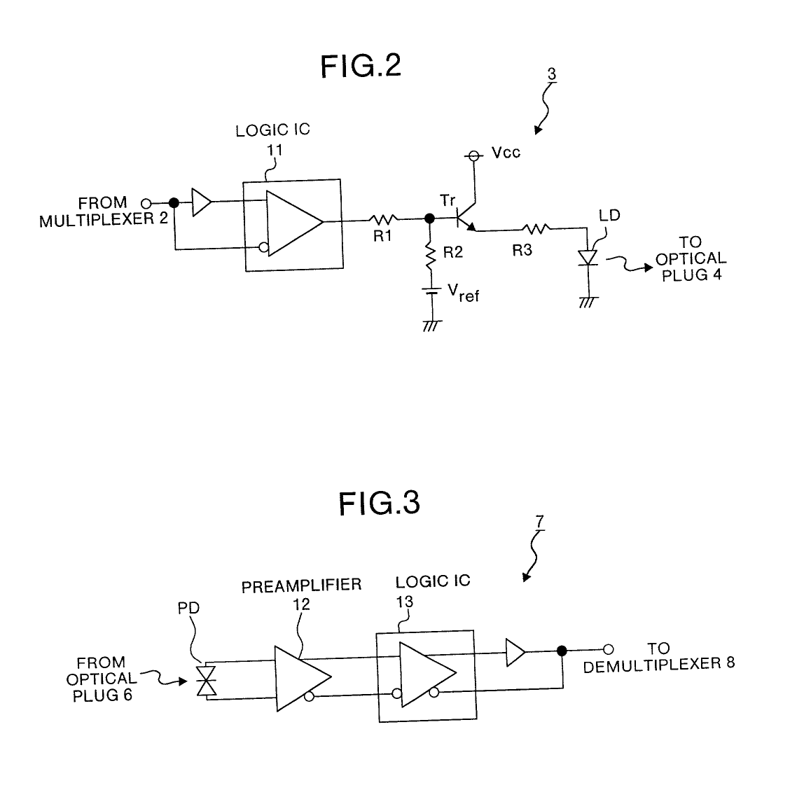

Referring now to FIG. 2 and FIG. 3, the detailed configurations of the transmission module 3 and the reception module 7 will be described. FIG. 2 is a diagram showing the detailed configuration of the transmission module 3. In FIG. 2, serial data output from the multiplexer 2 is passed to a simple configuration using a high-speed general logic IC 11, resistors R1 to R3, a transistor Tr, and a semiconductor laser LD. The simple configuration realizes a high-speed operation and the reduction in size. An oscillation wavelength of the semiconductor laser LD is 780 nm adapted to a plastic material. The configuration does not have a dedicated modulation circuit necessary to modulate the semiconductor laser LD in the conventional optical transmission link, thereby realizing a smaller size.

FIG. 3 is a diagram showing the detailed configuration of the reception module 7. Light signal supplied from the optical plug 6 is passed to a simple configuration using a high-speed photodiode PD, a preamplifier 12, and a high-speed general logic IC 13.

The multiplexer 2 may perform parallel-to-serial conversion by using a shift register, and the demultiplexer 8 may perform serial-to-parallel conversion by using a shift register.

In the first embodiment, the large-capacity high-speed parallel data communication between the transmission LSI chip 1 and the reception LSI chip 9 is realized only by coupling the transmission module 3 and the reception module 7 each having a simple configuration via the optical fiber 5, providing the multiplexer 2 between the transmission LSI chip 1 and the transmission module 3, and providing the demultiplexer 8 between the reception module 7 and the reception LSI chip 9. Consequently, the transmission-side device and the reception-side device having device scales almost equal to those of the transmission LSI chip 1 and the reception LSI chip 9, respectively, are realized.

A second embodiment of the invention will now be described. In the foregoing first embodiment, the transmission LSI chip 1 and the multiplexer 2 are physically separated from each other, and the reception LSI chip 9 and the demultiplexer 8 are also physically separated from each other. In the second embodiment, the multiplexer 2 is provided within the transmission LSI chip 1, and the demultiplexer 8 is provided within the reception LSI chip 9.

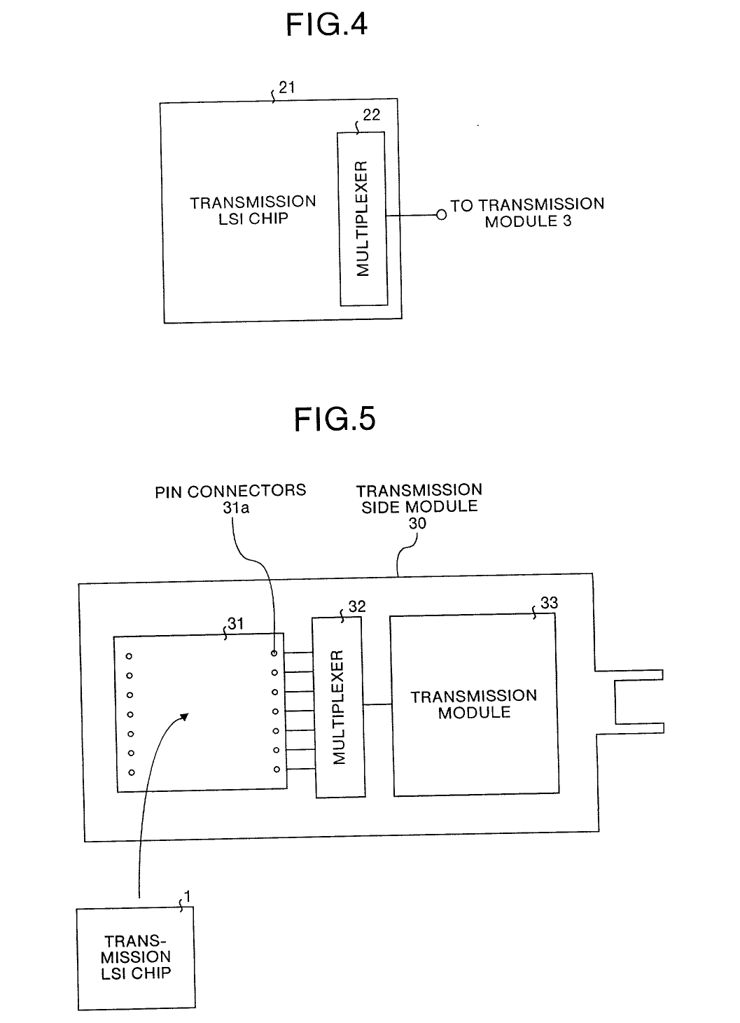

For example, as shown in FIG. 4, the circuit of a multiplexer 22 is provided within a transmission LSI chip 21, and a serial output from the multiplexer 22 is output to the transmission module 3. By the arrangement, for example, it becomes unnecessary to provide a wiring pattern or an interconnection between the transmission LSI chip 1 and the multiplexer 2, and the size and weight can be further reduced.

A third embodiment of the invention will now be described. In the second embodiment, the multiplexer 2 is provided within the transmission LSI chip 1 or the demultiplexer 8 is provided within the reception LSI chip 9. In the third embodiment, the transmission LSI chip 1 and the multiplexer 2 can be freely connected or disconnected. The reception LSI chip 9 and the demultiplexer 8 can be also freely connected or disconnected. When semiconductor chips have the same shapes and formats as the transmission LSI chip 1 and the reception LSI chip 9, data communication between the semiconductor devices can be performed.

For example, as shown in FIG. 5, a transmission-side module 30 has a transmission module 33 corresponding to the transmission module 3, a multiplexer 32 corresponding to the multiplexer 2, and an attaching part 31 having pin connectors 31a by which the transmission LSI chip 1 is detachably attached. Only by inserting corresponding pins of the transmission LSI chip 1 into the pin connectors 31a, the transmission-side device is completed.

As described above, in the case of a semiconductor chip having pins in the same positions as the pin connectors 31a, the transmission-side module 30 can be used. By devising the positions or form of the pin connectors 31a so as to be adapted to a plurality of pin arrangements and detecting a connecting relation, and switching the arrangement, semiconductor chips of other forms can be also used.

According to the third embodiment, since the attaching part adapted to the pin arrangement of the transmission LSI chip 1 or reception LSI chip 9 is provided, communication between flexible and general semiconductor chips can be realized.

A fourth embodiment of the invention will now be described. In the foregoing first embodiment, communication between the transmission LSI chip 1 and the reception LSI chip 9 is performed by using the optical fiber 5. In the fourth embodiment, infrared rays are used as the light signal, and a free space is used as a transmission medium.

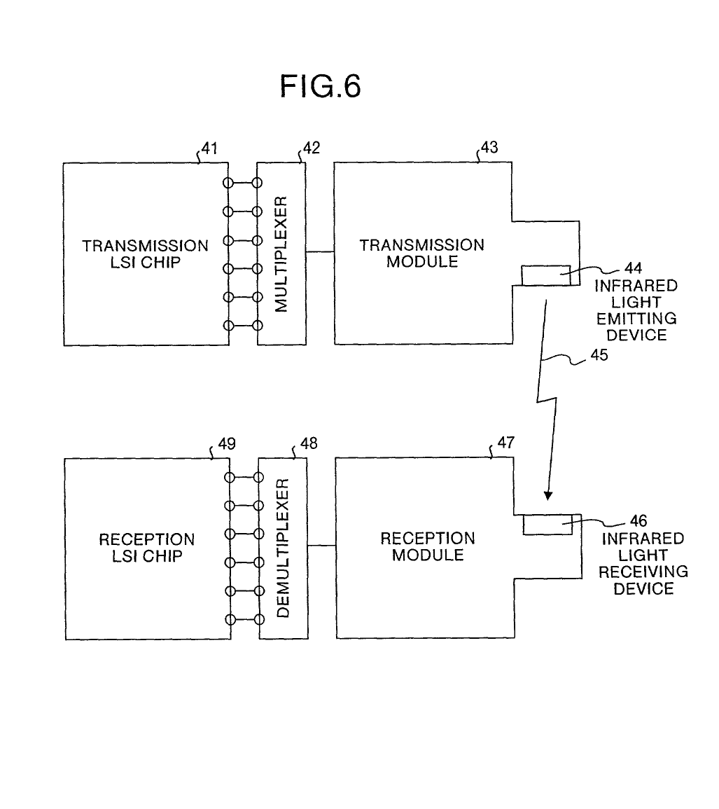

FIG. 6 is a diagram showing a schematic configuration of an LSI system as the fourth embodiment of the invention. In FIG. 6, a transmission LSI chip 41, a multiplexer 42, a transmission module 43, a reception module 47, a demultiplexer 48, and a reception LSI chip 49 correspond to the transmission LSI chip 1, multiplexer 2, transmission module 3, reception module 7, demultiplexer 8, and reception LSI chip 9 in the first embodiment, respectively. The transmission module 43 has an infrared ray emitting device 44 in place of the semiconductor laser LD, and the reception module 47 has an infrared ray receiving device 46 in place of the photoreceiving diode PD. Consequently, an infrared signal is transmitted from the infrared ray emitting device 44 toward the infrared pay receiving device 46.

In the fourth embodiment, in place of the transmission medium of the optical fiber 5, the free space is used as a transmission medium, so that a more flexible LSI system can be constructed. In place of the infrared rays, a signal such as electromagnetic radiation, for example, microwave or millimeter wave may be used.

A fifth embodiment of the invention will now be described. In the fifth embodiment, in place of the configuration of the foregoing first embodiment, a concealing function of concealing data between the transmission LSI chip 1 and the reception LSI chip 9 and a speed converting function are provided.

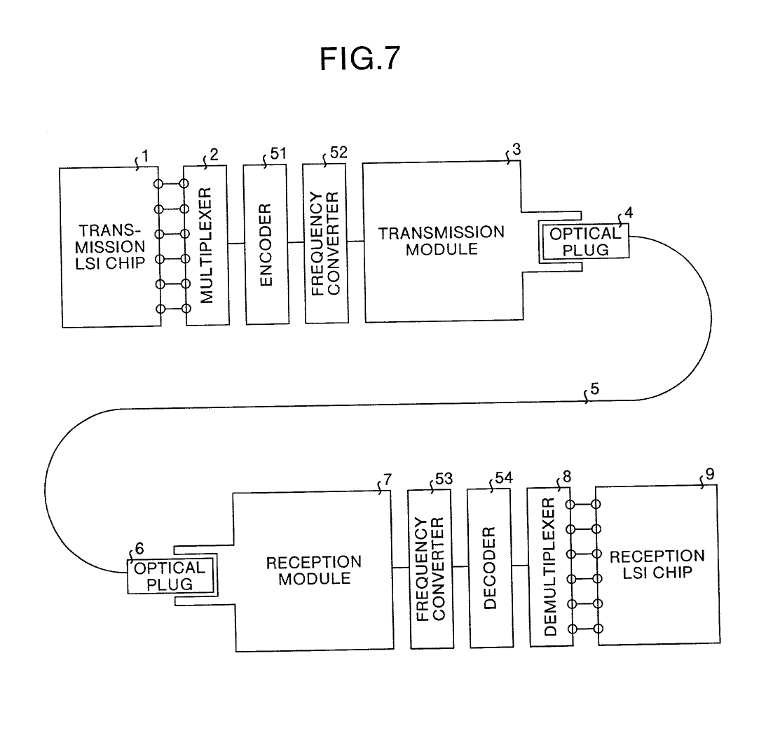

FIG. 7 is a diagram showing a schematic configuration of an LSI system as a fifth embodiment of the invention. In FIG. 7, in the LSI system, an encoder 51 for encoding transmission data and a frequency converter 52 for performing speed conversion between data speed of the transmission LSI chip 1 and data speed of the transmission module 3 are provided between the multiplexer 2 and the transmission module 3. A frequency converter 53 for performing speed conversion between the reception module 7 and the reception LSI chip 9 and a decoder 54 for decoding reception data are provided between the reception module 7 and the demultiplexer 8. The other configuration is the same as that of the first embodiment and the same reference numerals are given to the same elements.

The encoder 51 encodes serial data output from the multiplexer 2 on a predetermined data unit basis by a predetermined encoding system, adds redundancy data, and sends resultant data to the transmission module 3 side. On the other hand, the decoder 54 decodes the serial data received from the reception module 7 on a predetermined unit basis by using a predetermined encoding system on the basis of the redundancy data, and outputs the resultant decoded data to the demultiplexer 8.

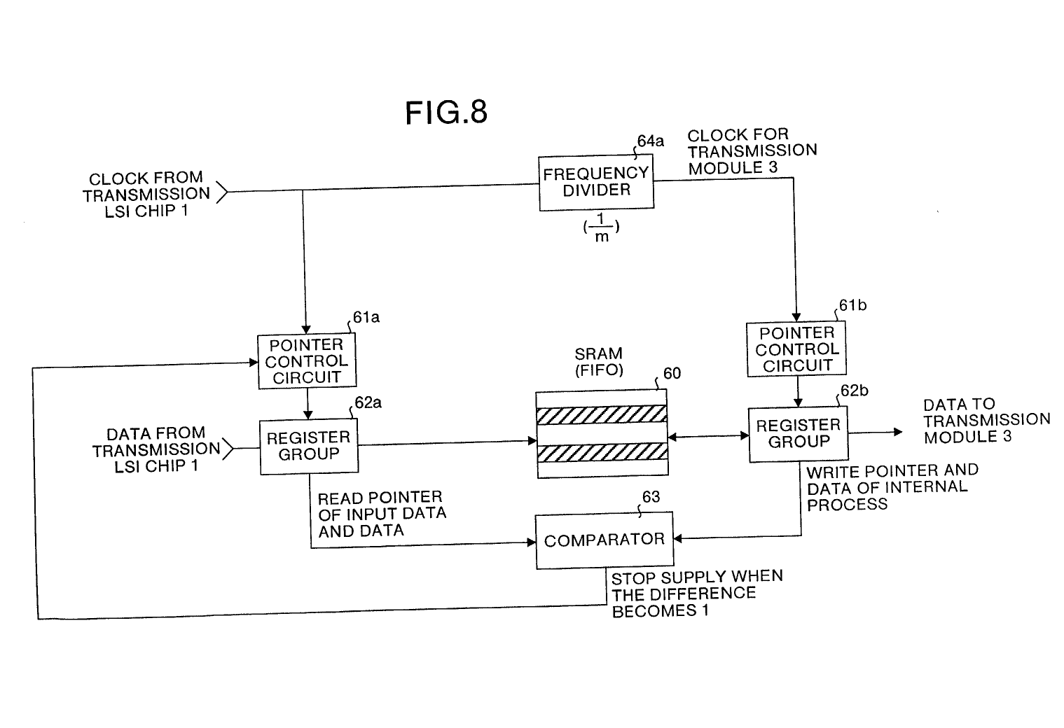

FIG. 8 is a diagram showing the detailed configuration of the frequency converter 52. In FIG. 8, a pointer control circuit 61a receives a clock from the transmission LSI chip 1 side and generates a read pointer of data to be stored into an SRAM 60 as an FIFO. The read pointer is stored into one of a group 62b of registers. Each time the read pointer is supplied to one of a group 62a of resisters, data from the transmission LSI chip 1 is also stored into another one of the group 62a of registers. On the other hand, a frequency divider 64a generates clocks for the transmission module 3 by frequency dividing the clock from the transmission LSI chip 1 by (m).

A pointer control circuit 61b receives the clock for the transmission module 3 and generates a write pointer. The write pointer is stored into one of the group 62b of registers. A comparator 63 obtains a difference between the read pointer and the write pointer.

When the difference between the read pointer and the write pointer is larger than “1”, the data stored in the group 62a of registers is stored into the SRAM 60, and data stored in the SRAM 60 is output to the transmission module 3 side via the register group 62b. When the difference between the read pointer and the write pointer is “1”, the supply of data from the transmission LSI chip 1 is stopped. Consequently, the speed conversion between the transmission LSI chip 1 side and the transmission module 3 side can be properly performed.

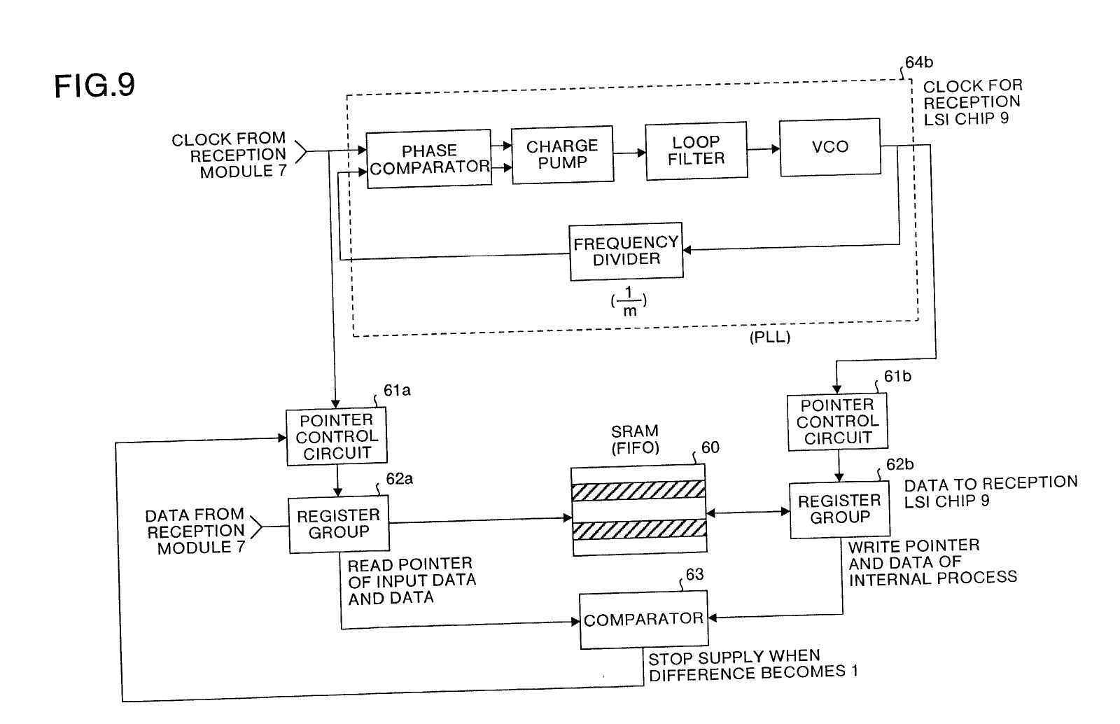

FIG. 9 is a diagram showing the detailed configuration of the frequency converter 53. The frequency converter 53 has a PLL circuit 64b in place of the frequency divider 64a shown in FIG. 8. The other configuration is the same, and the same reference numerals are given to the same elements. The operation is the same as the speed converting operation shown in FIG. 8.

In the fifth embodiment, data transferred between the transmission LSI chip 1 and the reception LSI chip 9 is concealed, so that secure communication can be conducted. Moreover, the speed conversion is performed, so that efficient communication can be carried out.

A sixth embodiment of the invention will now be described. Although the first to fifth embodiments relates to one-way communication, the sixth embodiment realizes bi-directional communication between semiconductor chips.

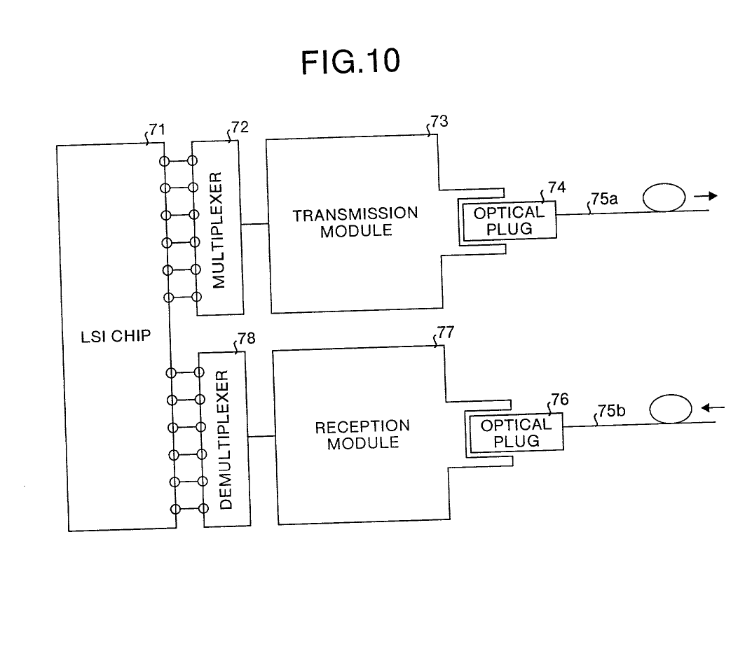

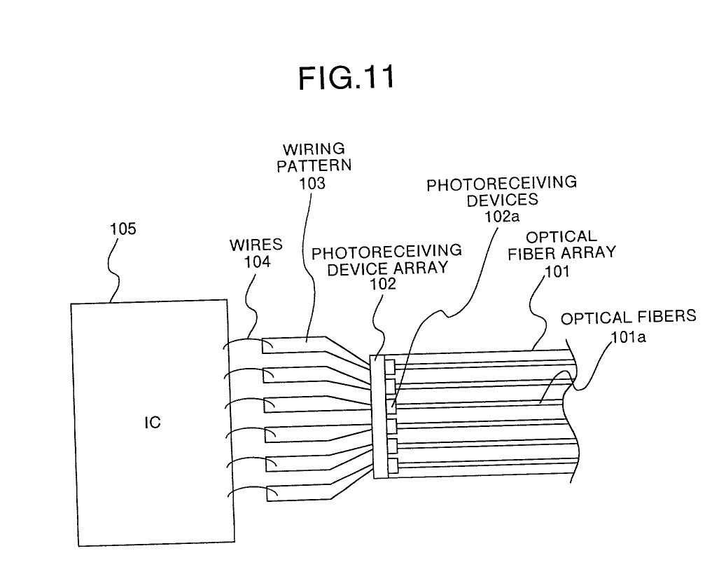

FIG. 10 is a diagram showing a schematic configuration of an LSI system as the sixth embodiment of the invention. In FIG. 10, an LSI chip 71 is a semiconductor chip capable of performing transmitting/receiving processes and has a plurality of output terminals for outputting data and a plurality of input terminals for inputting data. The plurality of output terminals are connected to a multiplexer 72 and the plurality of input terminals are connected to a demultiplexer 78. In a manner similar to the multiplexer 2, the multiplexer 72 converts the supplied parallel data to serial data and outputs the serial data to a transmission module 73. On the other hand, the demultiplexer 78 converts the serial data supplied from a reception module 77 to parallel data adapted to the plurality of input terminals, and outputs the parallel data to the LSI chip 71.

The transmission module 73 and the reception module 77 correspond to the transmission module 3 and the reception module 7 shown in the first embodiment, respectively, and have the same configurations. Optical plugs 74 and 76 correspond to the optical plugs 4 and 6 and have the same configuration. Each of optical fibers 75a and 75b corresponds to the optical fiber 7 and has the same configuration as the optical fiber 7.

By using the configuration shown in FIG. 10, the LSI chip 71 can realize large-capacity and high-speed data communication with an other LSI chip. Specifically, in spite of its small size and light weight, this LSI system has the function equivalent to that of a transmission/reception terminal by an LSI chip. By using the LSI system having the function of the transmission/reception terminal, therefore, a network can be configured. For example, a network of any type such as a bus type, star type, or ring type can be configured.

An LSI system may be configured only by the transmission-side device having the transmission LSI chip 1, multiplexer 2, and transmission module 3 shown in the foregoing first embodiment. By using the LSI system, broadcast communication can be realized.

An LSI system can be also configured only by the reception-side device having the reception module 7, demultiplexer 8, and reception LSI chip 9 shown in the first embodiment. By using the LSI system, a reception system similar to a pager can be configured.

As a modification of the foregoing first to sixth embodiments, for example, a system can be configured in which the power supply of a transmission-side device is formed in a plug shape which is inserted into a receptacle, and a reception-side device is assembled in a household electrical appliance such as a television which receives the power supply, thereby using the transmission-side device as a host and the household electrical appliance as a client. Since the LSI system is small and light and can perform large-capacity and high-speed data communication as described above, it can be applied to a wide range from a household electrical appliance to a space development part.

As described above, according to one aspect of this invention, in the transmission-side device, a transmission-side semiconductor chip outputs a plurality of data sequences as parallel data from a plurality of output terminals. The multiplexer converts the parallel data output from the transmission-side semiconductor chip into serial data. The electro-optic converting module converts the serial data into a light signal and transmits the light signal to an optical transmission line. On the other hand, in the reception-side device, the photoelectric converting module receives the light signal supplied via the optical transmission line, converts the light signal into serial data, and outputs the serial data. The demultiplexer converts the serial data output from the photoelectric converting module to parallel data corresponding to a plurality of input terminals. The reception-side semiconductor chip receives the parallel data output from the demultiplexer via the plurality of input terminals. Consequently, an effect such that the transmission-side device and the reception-side device can perform large-capacity high-speed data communication with the device scale almost equal to that of the transmission-side semiconductor chip and the reception-side semiconductor chip is produced.

According to another aspect of this invention, the semiconductor chip outputs a plurality of data sequences from a plurality of output terminals as parallel data. The multiplexer is connected to the plurality of output terminals and converts the parallel data output from the semiconductor chip to serial data. The electro-optic converting module converts the serial data output from the multiplexer into a light signal and transmits the light signal to an optical transmission line. On the other hand, the photoelectric converting module converts the light signal received via the optical transmission line into serial data and outputs the serial data to the demultiplexer. The demultiplexer is connected to the plurality of input terminals, and converts the serial data supplied to the semiconductor chip into parallel data. The semiconductor chip receives the parallel data by a plurality of input terminals. Consequently, an effect such that, with the device scale almost equal to that of the semiconductor chip, large-capacity, high-speed, bi-directional data communication can be performed is produced.

Furthermore, the transmission-side semiconductor chip or the semiconductor chip and the multiplexer are connected to each other, and/or the reception-side semiconductor chip or the semiconductor chip and the demultiplexer are connected to each other in parallel in correspondence with the parallel data. In such a manner, the multiplexer converts parallel data into serial data and the demultiplexer converts serial data into parallel data. Thus, an effect such that large capacity, high speed data communication can be realized with simple configuration and the device scale which is about the same as that of semiconductor chips is produced.

Furthermore, the multiplexer is provided within the transmission-side semiconductor chip or the semiconductor chip, and/or the demultiplexer is provided within the reception-side semiconductor chip or the semiconductor chip. Consequently, an effect such that the size and weight of the device can be further reduced is produced.

Furthermore, by an attaching part, the transmission-side semiconductor chip, the reception-side semiconductor chip, or the semiconductor chip can be detachably attached via a pin connector. Consequently, an effect such that a plurality of semiconductor chips can be replaced and flexible, efficient data communication can be therefore performed is produced.

Furthermore, the optical transmission line is an optical fiber, and the electro-optic converting module and/or the photoelectric converting module are/is connected to the optical fiber by using a connector. Therefore, an effect such that the electro-optic converting module and the photoelectric converting module are easily attached/detached and reliable data communication can be performed is produced.

Furthermore, the electro-optic converting module converts the serial data into an infrared ray signal and outputs the infrared ray signal to a free space, and the photoelectric converting module converts the infrared ray signal to serial data. Consequently, an effect such that flexibility of data communication between semiconductor chips or the like can be increased is produced.

Furthermore, the encoding unit is connected between the multiplexer and the electro-optic converting module and encodes serial data output from the multiplexer, and the decoding unit is connected between the photoelectric converting module and the demultiplexer, and decodes serial data output from the photoelectric converting module. Thus, an effect such that security of data communication between semiconductor chips or the like can be increased is produced.

Furthermore, the transmission-side speed converting unit is connected between the multiplexer and the electro-optic converting module and converts speed of serial data output from the multiplexer, and the reception-side speed converting unit is connected between the photoelectric converting module and the demultiplexer, and converts speed of serial data output from the photoelectric converting module. Consequently, an effect such that data communication between semiconductor chips or the like can be efficiently performed is produced.

According to still another aspect of this invention, the transmission-side semiconductor chip outputs a plurality of data sequences as parallel data from a plurality of output terminals. The multiplexer converts the parallel data output from the transmission-side semiconductor chip into serial data. The electro-optic converting module converts the serial data into a light signal and transmits the light signal to an optical transmission line. Consequently, an effect such that large-capacity, high-speed broadcasting data communication can be performed with a device scale almost equal to that of the transmission-side semiconductor chip is produced.

According to still another aspect of this invention, the photoelectric converting module receives a light signal supplied via an optical transmission line, converts the light signal into serial data, and outputs the serial data. The demultiplexer converts the serial data output from the photoelectric converting module to parallel data corresponding to a plurality of input terminals. The reception-side semiconductor chip receives the parallel data output from the demultiplexer via the plurality of input terminals. Consequently, an effect such that data of a large capacity can be received at high speed with a device scale almost equal to that of the reception-side semiconductor chip is produced.

According to still another aspect of this invention, the semiconductor chip outputs a plurality of data sequences from a plurality of output terminals as parallel data. The multiplexer is connected to the plurality of output terminals, and converts the parallel data output from the semiconductor chip to serial data. The electro-optic converting module converts the serial data output from the multiplexer to a light signal and transmits the light signal to an optical transmission line. On the other hand, the photoelectric converting module converts the light signal received via the optical transmission line into serial data and outputs the serial data to the demultiplexer. The demultiplexer is connected to the plurality of input terminals and converts the serial data supplied to the semiconductor chip into parallel data. The semiconductor chip receives the parallel data by a plurality of input terminals. Thus, an effect such that large-capacity, high-speed, bi-directional data communication can be performed with a device scale almost equal to that of the semiconductor chip is produced.

Furthermore, the transmission-side semiconductor chip or the semiconductor chip and the multiplexer are connected to each other, and/or the reception-side semiconductor chip or the semiconductor chip and the demultiplexer are connected to each other in parallel in correspondence with the parallel data. The multiplexer converts parallel data into serial data, and the demultiplexer converts serial data into parallel data. Consequently, an effect such that large-capacity, high-speed data communication can be realized with a simple configuration and a device scale almost equal to that of the semiconductor chip or the like is produced.

Furthermore, the multiplexer is provided within the transmission-side semiconductor chip or the semiconductor chip, and/or the demultiplexer is provided within the reception-side semiconductor chip or the semiconductor chip. Thus, an effect such that the size and weight of the device can be further reduced is produced.

Furthermore, by an attaching part, the transmission-side semiconductor chip, the reception-side semiconductor chip, or the semiconductor chip can be detachably attached via a pin connector. Consequently, an effect such that a plurality of semiconductor chips or the like may be replaced, and flexible and efficient data communication can be therefore performed is produced.

Furthermore, the optical transmission line is an optical fiber, and the electro-optic converting module and/or the photoelectric converting module are/is connected to the optical fiber by using a connector. Thus, an effect such that the electro-optic converting module and the photoelectric converting module are easily attached/detached and secure data communication can be performed is produced.

Furthermore, the electro-optic converting module converts the serial data into an infrared ray signal and outputs the infrared ray signal to a free space, and the photoelectric converting module converts the infrared ray signal to serial data. Consequently, an effect such that flexibility of data communication between semiconductor chips or the like can be increased is produced.

Furthermore, the encoding unit is connected between the multiplexer and the electro-optic converting module, and encodes serial data output from the multiplexer. The decoding unit is connected between the photoelectric converting module and the demultiplexer, and decodes serial data output from the photoelectric converting module. Consequently, an effect such that security of data communication between semiconductor chips or the like can be increased is produced.

Furthermore, transmission-side speed converting unit is connected between the multiplexer and the electro-optic converting module, and converts speed of serial data output from the multiplexer. The reception-side speed converting unit is connected between the photoelectric converting module and the demultiplexer, and converts speed of serial data output from the photoelectric converting module. Thus, an effect such that data communication between semiconductor chips or the like can be efficiently conducted is produced.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An LSI system comprising a transmission-side device and a reception-side device,
the transmission-side device including,
a transmission-side semiconductor chip which outputs a plurality of data sequences as parallel data from a plurality of output terminals;
a multiplexer which converts the parallel data output from said transmission-side semiconductor chip into serial data; and
an electro-optic converting module which converts said serial data into a light signal and transmits the light signal to an optical transmission line, and
the reception-side device including,
a photoelectric converting module which receives the light signal supplied via said optical transmission line, converts the light signal into serial data, and outputs the serial data,
a demultiplexer which converts the serial data output from said photoelectric converting module to parallel data corresponding to a plurality of input terminals; and
a reception-side semiconductor chip which receives the parallel data output from said demultiplexer via the plurality of input terminals.

2. The LSI system according to claim 1, wherein said transmission-side semiconductor chip or said semiconductor chip and said multiplexer are connected to each other, and/or said reception-side semiconductor chip or said semiconductor chip and said demultiplexer are connected to each other in parallel in correspondence with said parallel data.

3. The LSI system according to claim 1, wherein said multiplexer is provided within said transmission-side semiconductor chip or said semiconductor chip, and/or said demultiplexer is provided within said reception-side semiconductor chip or said semiconductor chip.

4. The LSI system according to claim 1, further comprising an attaching part to which said transmission-side semiconductor chip, said reception-side semiconductor chip, or said semiconductor chip is detachably attached via a pin connector.

5. The LSI system according to claim 1, wherein
said optical transmission line is an optical fiber, and
said electro-optic converting module and/or said photoelectric converting module are/is connected to said optical fiber through a connector.

6. The LSI system according to claim 1, wherein
said optical transmission line is a free space,
said electro-optic converting module converts said serial data into an infrared ray signal and outputs the infrared ray signal, and
said photoelectric converting module converts said infrared ray signal to serial data.

7. The LSI system according to claim 1, further comprising at least an encoding unit or a decoding unit, and
when said encoding unit is provided, it is connected between said multiplexer and said electro-optic converting module, and it encodes serial data output from said multiplexer, and
when said decoding unit is provided, it is connected between said photoelectric converting module and said demultiplexer, and it decodes serial data output from said photoelectric converting module.

8. The LSI system according to claim 1, further comprising at least a transmission-side speed converting unit or a reception-side speed converting unit, and
when said transmission-side speed converting unit is provided, it is connected between said multiplexer and said electro-optic converting module, and it converts speed of serial data output from said multiplexer, and
when said reception-side speed converting unit is provided, it is connected between said photoelectric converting module and said demultiplexer, and it converts speed of serial data output from said photoelectric converting module.

9. An LSI system comprising:
a semiconductor chip which outputs a plurality of data sequences from a plurality of output terminals as parallel data and receiving parallel data from a plurality of input terminals;
a multiplexer connected to said plurality of output terminals and which multiplexer converts the parallel data output from said semiconductor chip to serial data;
a demultiplexer connected to said plurality of input terminals and which demultiplexer converts the serial data supplied to said semiconductor chip to parallel data;
an electro-optic converting module which converts said serial data output from said multiplexer into a light signal and transmits the light signal to an optical transmission line; and
a photoelectric converting module which converts the light signal received via the optical transmission line into serial data and outputs the serial data to said demultiplexer.

10. The LSI system according to claim 9, wherein said transmission-side semiconductor chip or said semiconductor chip and said multiplexer are connected to each other, and/or said reception-side semiconductor chip or said semiconductor chip and said demultiplexer are connected to each other in parallel in correspondence with said parallel data.

11. The LSI system according to claim 9, wherein said multiplexer is provided within said transmission-side semiconductor chip or said semiconductor chip, and/or said demultiplexer is provided within said reception-side semiconductor chip or said semiconductor chip.

12. The LSI system according to claim 9, further comprising an attaching part to which said transmission-side semiconductor chip, said reception-side semiconductor chip, or said semiconductor chip is detachably attached via a pin connector.

13. The LSI system according to claim 9, wherein
said optical transmission line is an optical fiber, and
said electro-optic converting module and/or said photoelectric converting module are/is connected to said optical fiber through a connector.

14. The LSI system according to claim 9, wherein
said optical transmission line is a free space,
said electro-optic converting module converts said serial data into an infrared ray signal and outputs the infrared ray signal, and
said photoelectric converting module converts said infrared ray signal to serial data.

15. The LSI system according to claim 9, further comprising at least an encoding unit or a decoding unit, and
when said encoding unit is provided, it is connected between said multiplexer and said electro-optic converting module, and it encodes serial data output from said multiplexer, and
when said decoding unit is provided, it is connected between said photoelectric converting module and said demultiplexer, and it decodes serial data output from said photoelectric converting module.

16. The LSI system according to claim 9, further comprising at least a transmission-side speed converting unit or a reception-side speed converting unit, and
when said transmission-side speed converting unit is provided, it is connected between said multiplexer and said electro-optic converting module, and it converts speed of serial data output from said multiplexer, and
when said reception-side speed converting unit is provided, it is connected between said photoelectric converting module and said demultiplexer, and it converts speed of serial data output from said photoelectric converting module.

17. A semiconductor device comprising:
a transmission-side semiconductor chip which outputs a plurality of data sequences as parallel data from a plurality of output terminals;
a multiplexer which converts the parallel data output from said transmission-side semiconductor chip into serial data; and
an electro-optic converting module which converts said serial data into a light signal and transmits the light signal to an optical transmission line.

18. A semiconductor device comprising:
a photoelectric converting module which receives a light signal supplied via an optical transmission line, converts the light signal into serial data, and outputs the serial data;
a demultiplexer which converts the serial data output from said photoelectric converting module to parallel data corresponding to a plurality of input terminals; and
a reception-side semiconductor chip which receives the parallel data output from said demultiplexer via the plurality of input terminals.

19. A semiconductor device comprising:
a semiconductor chip which outputs a plurality of data sequences from a plurality of output terminals as parallel data and receiving parallel data from a plurality of input terminals;
a multiplexer connected to said plurality of output terminals, which converts the parallel data output from said semiconductor chip to serial data;
a demultiplexer connected to said plurality of input terminals, which converts the serial data supplied to said semiconductor chip into parallel data;
an electro-optic converting module which converts said serial data output from said multiplexer to a light signal and transmits the light signal to an optical transmission line; and
a photoelectric converting module which converts the light signal received via the optical transmission line into serial data and outputs the serial data to said demultiplexer.
